(19) United States
(12) Patent Application Publication
(10) Pub. No.: US 2003/0048578 A1
(43) Pub. Date: Mar. 13, 2003

(54) Magnetic head, method of manufacturing the same and magnetic disc apparatus with the same

(75) Inventors: Hiroshi Kikuchi, Zushi (JP); Toshimitsu Noguchi, Yokohama (JP); Noriyuki Saiki, Odawara (JP); Gen Oikawa, Odawara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/222,164

(22) Filed: Aug. 15, 2002

(30) Foreign Application Priority Data
Sep. 12, 2001 (JP) 2001-276900

(51) Int. Cl. G11B 5/17

(52) U.S. Cl. 360/123

(57) ABSTRACT

A non-magnetic heat sink for dissipating heat generated at a coil is arranged on a recording head portion. With such structure, a magnetic head for allowing high recording density and a magnetic disc apparatus using the same are realized.

### BACKGROUND OF THE INVENTION

The present invention relates to a magnetic head primarily used to write magnetic record to a hard disc, method of manufacturing the same, and a magnetic disc apparatus with the same.

As is well known to those skilled in the art, a hard disc apparatus includes as its main components a magnetic disc as a magnetic recording medium, a magnetic head for writing/reading magnetic recording signals to/from the disc, a servo mechanism for having the magnetic head access a predetermined position on the disc, and an electric circuit for signal processing and so on.

One of the most important items of performance of the hard disc apparatus is areal recording density, and it is general to employ, as the magnetic head used for improving the recording density, a high performance magnetic head of a structure wherein a recording head for writing the magnetic recording signal to a recording medium of a disc and a GMR (Giant Magneto-Resistive) sensor of a magneto-resistive element which is a reading head for converting the magnetic signal into an electric signal are laminated.

Conventional magnetic head structures are described in U.S. Pat. No. 5, 285, 340, Y. Sakurai et. al. and IEEE Tran. On Magnetics, Vol. 30, , No. 6 (1994) p.3894-p.3896. An example thereof is shown in FIGS. 7 and 8. FIG. 7 is a perspective view of a general magnetic head, and FIG. 8 is a sectional view taken along line VIII-VIII in FIG. 7. In the drawings, an insulating film 102 of alumina or the like is laid on a hard substrate 101 of a material such as alumina titanium carbide, a lower shield 103 of the GMR sensor is formed in a predetermined portion on the insulating film 102, a GMR laminated film 104 and an insulating film 105, which become the GMR sensor and the insulating film, are formed on the lower shield 103, and an upper shield 106 is formed on the insulating film 105. It is generally employed that such an upper shield film 106 is concurrently serves as a lower magnetic core of the recording head.

A non-magnetic layer 107 for shield separation is formed on the upper shield film 106. A lower magnetic core 108 of a recording portion is formed on the upper shield film 106. A protective film 109 of alumina or the like is formed. Then, the lower magnetic core 108 and the protective film 109 are flattened once by polishing working such as CMP (Chemical Mechanical Polishing) so that they become flush with each other to provide a surface B

Next, a magnetic gap 110 and a track portion magnetic substance 111 are formed, and a track width is adjusted by trimming. Furthermore, a coil lower insulating layer 112, a coil 113, a coil upper insulating layer 114 and an upper magnetic core 115 for driving the recording head are formed. Lastly, a protective film 116 of the alumina or the like covers the entirety. After a large number of such magnetic heads are simultaneously formed on the substrate 101, they are separated into each individual head including the substrate. Working such as polishing is done on a air bearing surface A to complete the magnetic head.

While such a magnetic head is manufactured by combining a thin film forming technology such as sputtering with various film forming technologies such as electroplating, a photolithographic technology is generally used in order to form various films at predetermined positions.

To realize high magnetic recording density, it is necessary to simultaneously increase linear recording density and track density. To increase the track density, it is necessary to simultaneously narrow the track width of the recording head and that of the GMR sensor, which has been an important subject matter in improving the magnetic head performance. Technical issues required to such magnetic heads are described in detail in Journal of the Electrochemical Society, 146 No. 6 (1999) p.2092 to p.2096, by T. Osaka et. al.; IEEE Tran. On Magnetics, Vol. 28 No. 5 (1992) p.2103 to p.2105, by S. Sahami et. al.; IEEE Tran. On Magnetics, Vol. 26 No. 5 (1990) p.1331 to p.1333 by A. B. Smith et. al.; and so on for instance.

One of the most important items of performance of the hard disc apparatus is a transfer rate of a recording signal, and various ideas are presented in order to realize a fast transfer rate. One of such ideas is to make rotation of the magnetic disc in high speed and to increase in signal recording frequency or the like. In particular, an attempt is made to reduce length of the upper magnetic core 115 and thereby reduce a magnetic path length as an effective means for speeding up the recording head. To reduce the magnetic path length in such a way, it is effective to render a sectional form of the coil 113 in the core smaller. A counter-measure to increase the coil density by rendering pitch of the coil narrow has been taken.

However, increase in the coil density and increase in recording frequency inevitably cause increase in an amount of Joule heat generated in the coil portion. Recent increase in the transfer rate in a magnetic disc apparatus is so remarkable that the increase in the transfer rate and the increase in recording frequency synergistically act, causing a problem that influence of the heat at the coil portion also affects the magnetic head performance.

To be more specific, as a result that the Joule heat generated in the coil portion placed close to the narrow track portion is conducted to the core portion and the track portion, the recording track portion projects to the air bearing surface due to thermal expansion of the recording head, that is, a phenomenon occurs that the substance in the gap protrudes. A similar phenomenon also occurs in the reading head portion, where the GMR element may protrudes to the air bearing surface due to the thermal expansion. Such thermal deformation of the track portion also causes various problems that the track portion possibly comes into contact with the recording medium in a head of which flying height is reduced to 10 nm or so. Specifically, it causes a signal noise, a sliding obstruction and so on.

Furthermore, a degree of influence of such problems also varies dependent on a temperature of the entire magnetic disc apparatus, and so there is consequently a problem that a recording characteristic becomes unstable dependent on a temperature environment in which the apparatus is placed.

As for such problems, it is possible to think that the above problems may be solved by designing it so that a deformation amount in a specified temperature condition will be optimum to the recording characteristic in the expectation of the deformation due to thermal expansion. However, as it requires a considerable economic burden to always keep the temperature of the entire magnetic disc apparatus constant, such an approach can only be used for certain apparatuses allowing such a burden.

With these problems, as for recent magnetic heads, it has been required to solve the problems caused by heat generation at the coil by an entirely new method.

An object of the present invention is to provide a new magnetic head for solving these problems and a high performance magnetic disc apparatus using this magnetic head.

Another object is to provide a specific manufacturing technology of the magnetic head for solving these problems.

### SUMMARY OF THE INVENTION

In the present invention, in order to attain the above objects, a heat sink is arranged close to the recording head. It is possible, by such arrangement of the heat sink, to effectively prevent the influence of the thermal expansion of the core and track portions due to generation of the Joule heat.

### BRIEF DESCRIPTION OF THE DRAWINGS

These and other features, objects and advantages of the present invention will become more apparent from the following description when taken in conjunction with the accompanying drawings wherein:

FIG. 1 is a perspective view showing a first embodiment of a magnetic head according to the present invention, in which a protective film is omitted for the purpose of intelligibility;

FIG. 2 is a sectional view taken along line II-II in FIG. 1;

FIG. 3 is a perspective view of a second embodiment of the magnetic head according to the present invention, in which a protective film is omitted for the purpose of intelligibility;

FIG. 4 is a perspective view of a third embodiment of the magnetic head according to the present invention, in which a protective film is omitted for the purpose of intelligibility;

FIG. 5 is a plan view of a fourth embodiment of the magnetic head according to the present invention;

FIG. 6 is a perspective view showing an embodiment of a magnetic disc apparatus incorporating the magnetic head according to the present invention;

FIG. 7 is a perspective view of a prior art magnetic head, in which a protective film is omitted for the purpose of intelligibility; and

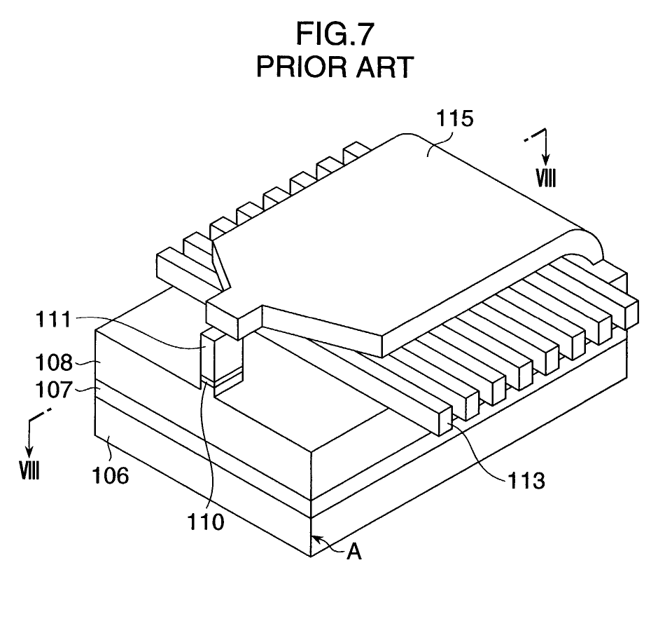

FIG. 8 is a sectional view taken along line VIII-VIII in FIG. 7.

### DETAILED DESCRIPTION OF PREFERRED EMBODIMENTS

Hereinafter, embodiments of the present invention will be described with reference to the drawings.

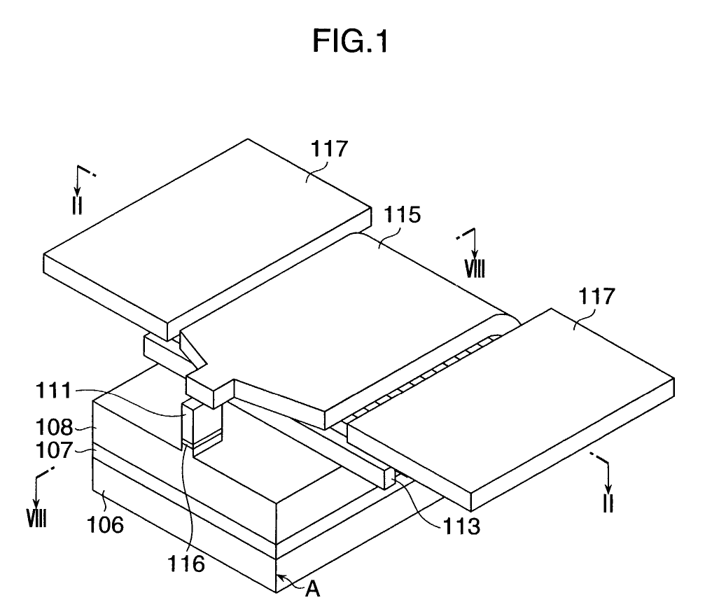

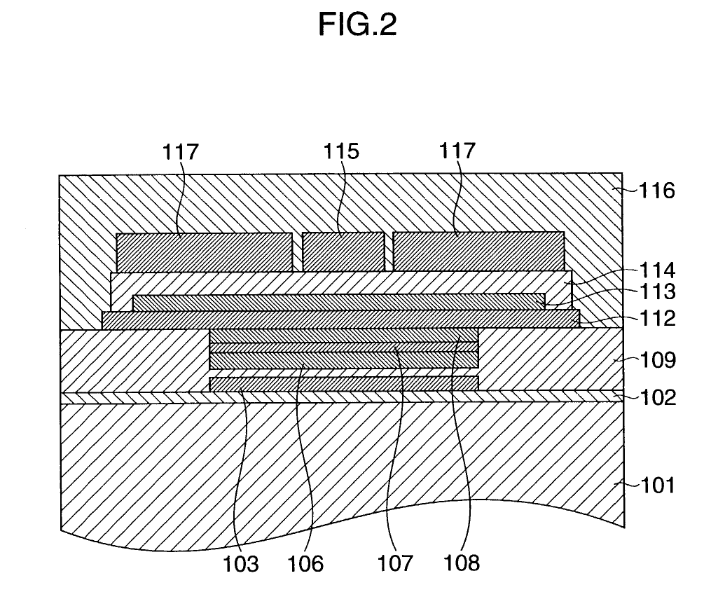

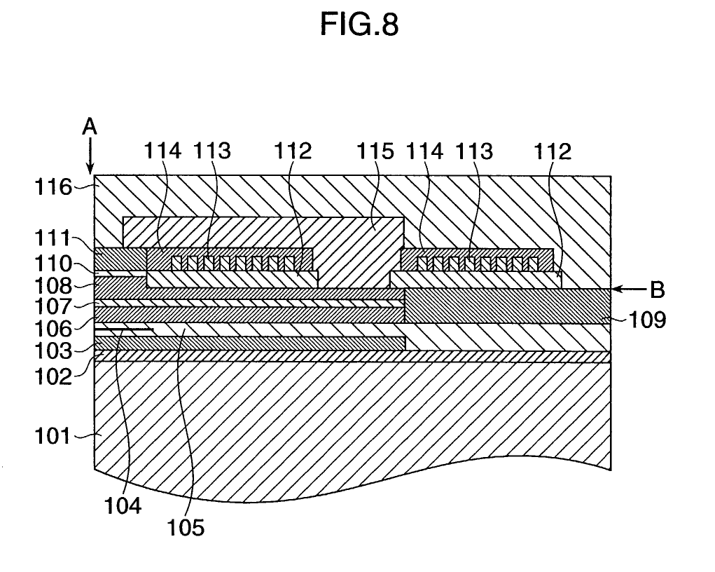

FIG. 1 is a perspective view showing a first embodiment of a magnetic head according to the present invention. In addition, FIG. 2 is a sectional view taken along line II-II in FIG. 1. Moreover, a sectional view taken along line VIII-VIII in FIG. 1 is the same as FIG. 8. A insulating film 102 of alumina or the like is laid on a hard substrate 101 of a material such as alumina titanium carbide. A lower shield 103 of a GMR sensor is formed in a predetermined portion of the insulating film 102. A GMR laminated film 104 and an insulating film 105 which become the GMR sensor and an insulating film are formed on the lower shield 103 (see FIG. 8), and an upper shield 106 is formed thereon. It is employed that the upper shield film 106 is also used generally to serve concurrently as a lower magnetic core of the recording head.

A non-magnetic layer 107 for shield separation is formed on the upper shield film 106. On the upper shield film 106, a lower magnetic core 108 of a recording portion and then a protective film 109 of the alumina or the like are deposited thereon. Then, the lower magnetic core 108 and the protective film 109 are flattened once by polishing such as CMP (Chemical Mechanical Polishing) so as to be flush with each other.

Next, a magnetic gap 110 and a track portion magnetic substance 111 are formed (see FIG. 8), and a track width is adjusted by trimming. Furthermore, a coil lower insulating layer 112, a coil 113, a coil upper insulating layer 114 and an upper magnetic core 115 for driving the recording head are formed. Up to this process, it can also be manufactured just as a prior art magnetic head.

In this embodiment, as shown in FIG. 1, heat sinks 117, which are non-magnetic and of high thermal conductivity, are arranged close to the upper magnetic core 115. The heat sinks 117 are formed by plating, for instance. After the heat sinks 117 are arranged, a protective film 116 of the alumina or the like lastly covers the entirety of the head. After a large number of the magnetic heads are simultaneously formed on the substrate 101, they are divided into each individual head including the substrate. The air bearing surface is worked by polishing and so on and the magnetic head is completed.

As shown in FIG. 2, the insulating film 102 of the alumina or the like is deposited in 0.5-μm thickness by a sputtering method on the entire surface of the substrate 101 of 5-inch diameter made from the alumina titanium carbide. The lower shield 103 of the GMR sensor is formed in 2-μm thickness in a predetermined portion of the insulating film 102 in a series of steps of sputtering, photoresist formation, ion milling and resist removal. The GMR laminated film 104 and the insulating film 105 which become the GMR sensor and the insulating film are formed on the lower shield 103 (see FIG. 8) so as to form a reading head element. As for details of the GMR sensor, a method known to those skilled in the art may be used.

In this embodiment, as an example, a laminated structure comprising the shield film layer 106 on one side of a magneto-resistive element, the non-magnetic metal layer 107 and the magnetic core layer 108 on one side of the recording head is formed on the insulating film 105. The following method may be used to form the laminated structure.

A Ni—Fe alloy to be a bed film for plating is deposited in 0.1-μm thickness by the sputtering method on the entire surface of the substrate and a photoresist is formed in a predetermined portion excluding the shape of the laminated structure on the base film. Next, a permalloy alloy to be the shield film layer 106 on one side of the magneto-resistive element is deposited in 1.5-μm thickness in the shape of the laminated structure by an electroplating method. The permalloy alloy is a Ni—Fe alloy including approximately 80 weight percent of Ni, and details thereof are known to those skilled in the art.

Next, a Ni—Sn alloy to be the non-magnetic metal layer 107 is deposited in 0.5-μm thickness on the shield film layer 106 by an electroplating method. This alloy plating can be deposited from approximately neutral plating solution including Ni ion, Sn ion and pyrophoric acid on condition that current density is 10 mA/cm², and it is possible to obtain a dense non-magnetic alloy including approximately 60 weight percent of Ni.

Next, as shown in FIG. 2, ternary alloy plating of Co—Ni—Fe to be the lower magnetic core 108 of the recording head is formed in 3.5-μm thickness on the non-magnetic metal layer 107 by the electroplating method. This alloy plating is also known to those skilled in the art, and it is possible to obtain a soft magnetic substance of which saturated magnetic flux density is 2.0 T. After forming the laminated structure, the resist is removed and the exposed base film for plating is removed by the ion milling, so that the laminated structure is manufactured.

Next, the protective film 109 of the alumina is deposited in 6.0-μm thickness on the entire surface of the substrate including the laminated structure by the sputtering method.

Next, the protective film 109 of the alumina is polished until the laminated structure is exposed by using a CMP method and the surface the alumina protective film 109 and the exposed surface of the magnetic core layer 108 of the laminated structure (see FIG. 8) a re flattened. The flattened surface is advantageous in improving accuracy of the recording head portion to be formed thereon. The polishing technology for the insulating film and metal using the CMP is already known to those skilled in the art.

The alumina film to be the magnetic gap 110 of the recording head is formed by the sputtering method in 0.2-μm thickness of the gap amount on the magnetic core layer 108 flattened (see FIG. 8), and the track portion magnetic substance 111 is formed in 4-μm thickness thereon by electroplating. The Co—Ni—Fe alloy plating of saturated magnetic flux density of 1.8 T can be adopted, as an example, for this magnetic substance 111. Next, the track width is adjusted by trimming. Details of this trimming are also known to those skilled in the art. In the trimming, a back-off amount is simultaneously adjusted to be 0.2-μm.

Next, a coil portion for driving the recording head is formed. As shown in FIG. 2, the coil lower insulating layer 112, the coil 113, the coil upper insulating layer 114 and the upper magnetic core 115 are formed. Thereafter, the insulating film such as the alumina or the like is deposited and is flattened by polishing work such as CMP to form the upper magnetic core 115. Alloy plating of 3-μm thickness is adopted for the upper magnetic core 115 as an example. Manufacturing of the coil portion is known to those skilled in the art. a 2-layer and 9-turn copper coil is selected as an example although not shown in FIG. 2.

Next, the heat sinks 117 which are non-magnetic and of high thermal conductivity as shown in FIG. 1 is arranged by gold plating. As for the heat sink, the electroplating method can be used, wherein a laminated seed film of Cr and Au is formed by the sputtering on the entire surface, and then the portions other than the heat sinks are covered by the photoresist and an electric current is supplied from the seed film. This plating method itself is known to those skilled in the art. As the heat sinks, two rectangular sinks of 50×100 μm² in 10-μm thickness are arranged on both sides of the upper magnetic core 115.

Lastly, the entirety is covered by a protective film 116 of the alumina or the like. Formation of a terminal for connecting the magnetic head to an external circuit is omitted from the description since it is known to those skilled in the art, but it does not mean that the terminal is unnecessary. A block (bar) including a plurality of the heads is cut from a wafer on which a large number of these heads are formed. Then, polishing of the air bearing surface, rail working of the air bearing surface, and formation of the head protective film are performed, and the bar is divided into a plurality of heads to complete the magnetic heads. Details of such separation of the bar, polishing of the air bearing surface and so on are also in the range known to those skilled in the art.

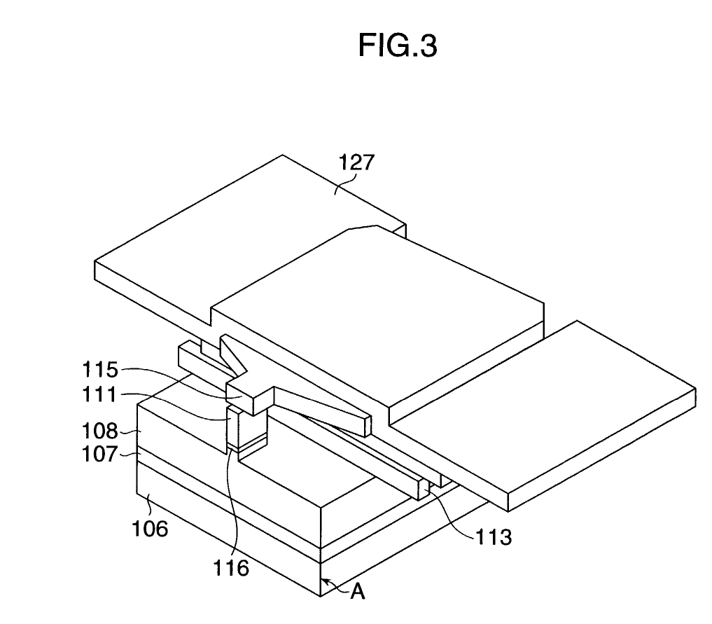

Next, a second embodiment of the present invention will be described with reference to FIG. 3.

FIG. 3 is a perspective view showing a second embodiment of the magnetic head according to the present invention. As shown in FIG. 3, a heat sink 127 is comprised of a central portion covering the upper magnetic core 115 and the portion expanding on both sides thereof and covering the coil 113. As the heat sink 127 and the upper magnetic core 115 are in contact with each other in the case of this embodiment, thermal conductivity can be further improved.

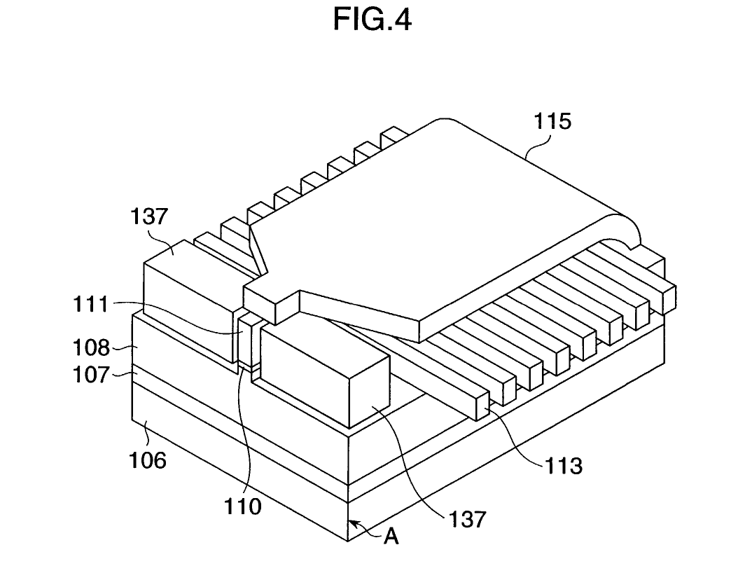

Next, a third embodiment of the present invention will be described with reference to FIG. 4.

FIG. 4 is a perspective view showing a third embodiment of the magnetic head according to the present invention. As shown in FIG. 4, heat sinks 137 are arranged on both sides of the track portion. In this embodiment, the heat from the coil 113 passes through the portion opposite the track portion magnetic substance of the upper magnetic core 115 to be conducted to the heat sink 137 so as to be dissipated here. As the heat sinks are arranged on the same face as the magnetic gap 110 in this embodiment, it is possible to further reduce the influence of thermal expansion of the track portion.

It is desirable, in the embodiments of the present invention described above, to form the heat sink to be used for the magnetic head by using a non-magnetic thermal conductivity material. The reason for requiring a non-magnetic nature is to prevent an unnecessary influence to a magnetic circuit of the magnetic head, and the thermal conductivity is required to effectively dissipate the heat generated in the coil portion.

As for non-magnetic thermal conductivity materials for the present invention, high thermal conductivity metallic materials such as Au, Ag, Cu, Sn, Zn, Pt, Pd and Cr or an alloy mainly composed thereof or a non-magnetic alloy including Ni, Fe and Co are desirable. The thermal conductivities of these materials are generally 50 to 400 W/mK, and 100 to 400 W/mK preferably, where a lower limit thereof is established for securing heat dissipation and an upper limit thereof is established from cost efficiency of available materials.

As for the heat sink of the present invention, a plurality of them may be arranged on the same face as the magnetic core as shown in FIG. 4, or it may also be arranged in contact with the core. It is desirable to be in contact with the magnetic core, since thermal resistance can be remarkably reduced thereby and so the operation as the heat sink becomes more effective.

In the present invention, it is also possible to arrange the heat sinks on the side of the track, in which case they are arranged on the same plane as the magnetic gap of the track portion. In this case, the influence of the thermal expansion of the track portion can be further reduced.

In the present invention, it is also possible and more desirable to combine a plurality of arrangements of various heat sinks and thereby increase volume of the entire heat sinks.

While the details of the arrangements of the heat sinks and the details of dimensions thereof according to the present invention should be determined at the optimum so as to be adapted to a detailed design of the magnetic head structure, it is generally desirable and necessary to render the heat sink of the present invention larger in total volume than the magnetic core portion.

While a variety of approaches may be used to arrange the heat sinks of the present invention on the magnetic head, it is optimum to use a plating method in order to form the non-magnetic thermal conductivity materials economically and accurately. It is desirable from this viewpoint to form the heat sinks of the present invention by the plating method. Furthermore, it is recommended to use a plating resist patterned by the photoresist in order to arrange the heat sinks with accuracy. As these plating technologies are often used for formation of magnetic materials of the magnetic head, detailed description thereof will be omitted.

It is possible, by using the magnetic head of the present invention, to provide a remarkably superior magnetic recording apparatus of 100-MHz or higher recording frequency, and furthermore, it is possible to provide a remarkably superior magnetic recording apparatus of 500-MHz or higher recording frequency. Surprisingly, the upper limit of the recording frequency in the case of using the present invention reaches 1500 MHz.

While it is possible to arrange the heat sinks of the present invention as the structures independent of the coil and magnetic core, it is also possible to enlarge a part of the coil to have the action of the heat sink, which case is also included in the present invention.

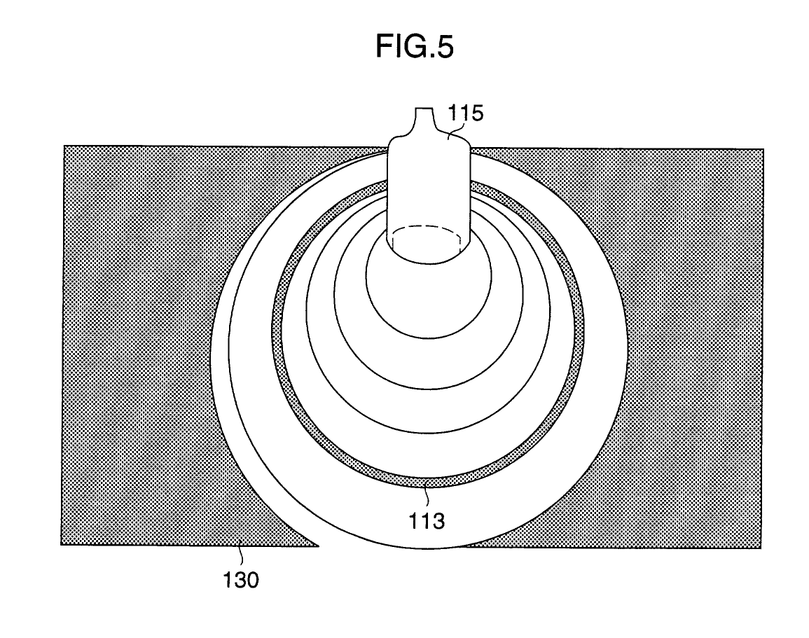

Hereinafter, an embodiment of the present invention wherein a part of the coil is enlarged, that is a fourth embodiment will be described with reference to FIG. 5.

FIG. 5 is a plan view showing a fourth embodiment of the magnetic head according to the present invention. In the drawing, reference numeral 115 denotes the upper magnetic core, and 113 denotes the coil. An outermost portion of the coil 113 has an enlarged part 130. The heat generated at the coil 113 is dissipated at the enlarged part 130.

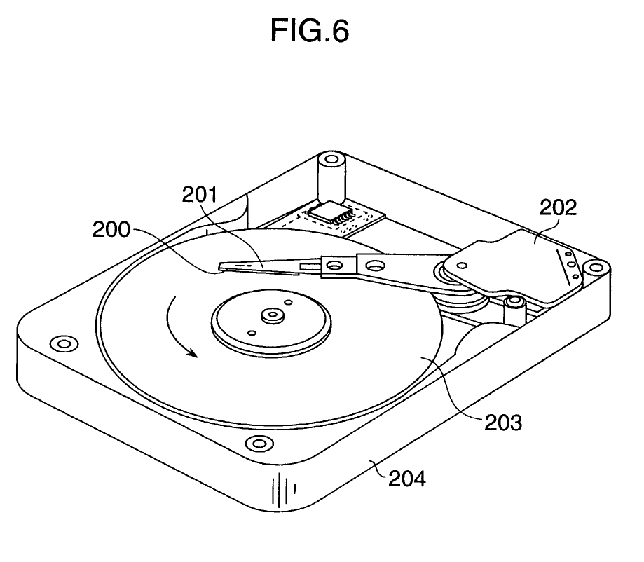

Hereinafter, an embodiment of a magnetic disc apparatus according to the present invention will be described with reference to FIG. 6.

FIG. 6 is a perspective view showing an embodiment of a magnetic disc apparatus incorporating the magnetic head according to the present invention. In the drawing, a magnetic head 200 is driven by a voice coil motor 202 implemented in advance on a suspension 201. A plurality of magnetic discs 203 as a recording medium are rotated by the same spindle. It is already known to those skilled in the art that, to use both sides of the disc 203 as the recording medium, two magnetic heads should normally be implemented to one magnetic disc. A magnetic disc apparatus 204 is completed by this manner.

The magnetic disc apparatus 204 of this embodiment employs the magnetic head 200 of the present invention and also employs the 2.5-inch diameter magnetic discs 203 having a medium of approximately 3500-Oe coercive force to use rotational speed of 4200 rpm, so that it has no problem of heat of the coil even if the recording frequency is 100 MHz or higher and also is capable of attaining a superior recording performance of 20 Gbit/square inch or higher recording density at track recording density of 44 kTPI (Track Per Inch) and linear recording density of 520 kBPI (Bit Per Inch).

In addition, it is possible to further improve the recording density by further narrowing the track width to 0.2-μm or less. In this case, track recording density of 100 kTPI (Track Per Inch) or more becomes possible by concurrently using the magnetic disc having a medium of 4500-Oe or higher coercive force, and remarkably superior recording performance of 100 Gbit/square inch or higher recording density can also be attained at linear recording density of 1000 kBPI (Bit Per Inch) or more.

Even if the recording frequency is 500 MHz or higher at such high recording density, the problems due to heat generation at the coil can be eliminated by using the magnetic head of the present invention. Furthermore, in the case where the present invention is adequately used, the upper limit of the recording frequency can reach 1 GHz and the upper limit of the recording density reaches 200 Gbit/square inch.

Because of the outstanding head structure of the present invention and the manufacturing method for implementing it, it is possible to provide the magnetic head usable for such high performance magnetic recording through a simple manufacturing process.

As described above, according to the present invention, it is possible to provide the high performance magnetic head having reduced influence of Joule heat of the coil portion. And it is possible to drastically solve the problems of the magnetic recording apparatus associated with the heat generation at the coil.

In addition, it is possible, by using the magnetic head of the present invention, to inexpensively obtain the magnetic disc apparatus of high performance and high reliability.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications to fall within the ambit of the appended claims.

What is claimed is:

1. A magnetic head comprising:
a magnetic head portion for recording comprising an upper magnetic core, a lower magnetic core, a track portion magnetic substance provided between said upper magnetic core and said lower magnetic core for forming a magnetic gap between the magnetic substance and said lower magnetic core, and a coil, and
a heat sink that is non-magnetic and of high thermal conductivity, wherein the heat from said coil is dissipated by said heat sink.

2. A magnetic head according to claim 1, wherein said heat sink is formed by Au, Ag, Cu, Sn, Zn, Pt, Pd, Cr or an alloy mainly composed thereof or a non-magnetic alloy including Ni, Fe and Co.

3. A magnetic head according to claim 1, wherein said heat sink has a thermal conductivity in a range of 100 to 400 W/mK.

4. A magnetic head according to claim 1, wherein said heat sink is formed by a plating method.

5. A magnetic head according to claim 1, wherein a plurality of said heat sinks are arranged close to said upper magnetic core.

6. A magnetic head according to claim 1, wherein said heat sink is placed in contact with said upper magnetic core.

7. A magnetic head according to claim 1, wherein said heat sink is arranged on the same plane as said track portion magnetic substance.

8. A magnetic head according to claim 1, wherein said heat sink is larger in volume than said magnetic core.

9. A magnetic head according to claim 1, wherein said heat sink is formed by an enlarged part of said coil.

10. A magnetic head according to claim 1, wherein due to said heat sink, driving at a frequency between 100 to 1500 MHz is allowed.

11. A magnetic disc apparatus including the magnetic head according to any one of claims 1 to 10.

12. A magnetic disc apparatus according to claim 11, wherein said apparatus can record at recording density of 20 to 200 Gbit/square inch.

13. A method of manufacturing a magnetic head, comprising the steps of:
forming a lower magnetic core on a non-magnetic layer;
forming a magnetic gap on the lower magnetic core;
forming a track portion magnetic substance on the magnetic gap;
forming a coil lower insulating layer;
forming a coil on the coil lower insulating layer;
forming an upper magnetic core on the coil;
and
forming a heart sink which is non-magnetic and of high thermal conductivity for dissipating the heat generated at the coil.
